(19) United States
(12) Patent Application Publication
(10) Pub. No.: US 2016/0092884 A1
(43) Pub. Date: Mar. 31, 2016

(54) SYSTEM AND METHOD OF CONDUCTING SELF ASSESSMENT FOR REGULATORY COMPLIANCE

(71) Applicant: ISGN Corporation, Palm Bay, FL (US)

(72) Inventors: Lisa Weaver, Columbia, MO (US); Paul Imura, Cary, NC (US)

(21) Appl. No.: 14/497,436

(22) Filed: Sep. 26, 2014

(51) Int. Cl. G06Q 30/00

(52) U.S. Cl. CPC G06Q 30/018

(57) ABSTRACT

A system and method for self-assessing a company's compliance with a preset regulatory framework. The system presents a plurality of questions that are based on particular regulatory requirements. In response to each question, the system receives an answer to each question, a measure of inherent risk associated with each question for the company, and a measure of control risk associated with each question for the organization. The system is then configured to calculate the residual risk associated with each question based on at least the received inherent risk and control risk. The system also allows a user to delegate a question to a second user and track the status of a question. In addition to delegating questions, the system provides for local help and help through communicating with a compliance expert.

### BACKGROUND

Consumer Financial Protection Bureau (CFPB) final rules were released to the mortgage industry in 2014 and incorporated over 5,000 pages of exam and regulatory guidelines. Lenders of all sizes, including financial institutions and non-financial institutions, need guidance in navigating the swirl of new regulations that burden even the strongest compliance teams. In order to avoid and mitigate hefty fines, lenders must fully understand and adhere to the new rules.

Various embodiments of the present systems and methods recognize and address the foregoing considerations, and others, of prior art systems and methods.

### SUMMARY OF THE VARIOUS EMBODIMENTS

In general, in various embodiments, a computer system is configured for: (1) presenting a plurality of questions to a user; (2) if the user is qualified to answer a particular question of the plurality of questions: (i) receiving an answer to the particular question; (ii) receiving a measurement of inherent risk associated with the subject matter of the particular question as it applies to the user; (iii) receiving a measurement of risk control associated with the particular question as it applies to the user; (3) at least partially in response to receiving the answer, the measurement of inherent risk and the measurement of risk control for the particular question, calculating a residual risk associated with the particular question as it applies to the user; (4) storing, in memory, the particular question, the received answer to the particular question, the received measurement of inherent risk, the received measurement of control risk, and the calculated residual risk; and (5) generating a self-assessment report based on the received answer, the received measurement of inherent risk, the received measurement of risk control, and the calculated residual risk for each one of the plurality of questions.

In various embodiments, a computer-implemented method of self-assessing compliance with regulatory rules is configured for: (1) presenting, by a processor, a plurality of questions that are based on regulatory requirements; (2) receiving, by a processor (i) an answer for each one of the plurality of questions for an organization; (ii) a measure of inherent risk associated with each one of the plurality of questions for the organization; and (iii) a measure of control risk associated with each one of the plurality of questions for the organization; and (3) calculating, by a processor, a residual risk for each one of the plurality of questions, wherein the residual risk is at least based in part on the received measure of inherent risk and the received measure of control risk for the respective question.

In general, in various embodiments, a computer system for conducting an assessment for compliance with a set of rules includes a means for presenting a plurality of questions to a user, a means for receiving an answer for each respective one of the plurality of questions, a means for receiving a measure of inherent risk associated with each respective one of the plurality of questions, a means for receiving a measure of a control risk associated with each respective one of the plurality of questions, a means for calculating a residual risk for each one of the plurality of questions, wherein the residual risk is at least partially based on the received measure of the control risk and the received measure of the inherent risk for the respective question, and a means for associating at least one of the received answer, the received measure of inherent risk, the received measure of control risk and the calculated residual risk with the respective question.

### BRIEF DESCRIPTION OF THE DRAWINGS

Various embodiments of systems and methods for the publication of user-selected information are described below. In the course of this description, reference will be made to the accompanying drawings, which are not necessarily drawn to scale and wherein:

FIG. 1 is a block diagram of an exemplary system for conducing self-assessments for regulatory compliance in accordance with an embodiment of the present system;

FIG. 2 is a block diagram of a self-assessment server that may be used in the system shown in FIG. 1;

FIG. 3 depicts a flowchart that generally illustrates a method for conducting self-assessments;

FIGS. 4-15 are exemplary screen displays of the system according to various embodiments; and

FIG. 16 illustrates an exemplary weighing schedule that may be used by the system of FIG. 1 for calculating the residual risk.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A system and method, according to various embodiments, for conducting a self-assessment by a user, presents the user with various questions related to one or more specific topics, such as compliance with the Consumer Financial Protection Bureau regulatory requirements, and the user answers the questions to evaluate (1) whether the company is complying with the regulations, (2) the company's risk associated with various regulations and (3) areas where the company needs to improve. In various embodiments, the user may be a representative or an employee of a company such as a bank or a mortgage company. In other embodiments, the company can be any suitable company that strives to meet or exceed predefined policies and procedures. The system also allows the user to delegate responding to a particular question to another user if the other user is more qualified to answer the particular question.

In addition, where the user does not understand the question being presented, the system includes a help function that allows the user to review a Best Practices answer that includes an explanation of the topic for which the question relates. Also, the system allows the user to select the Best Practices answer as their response for the particular question. In situations where the Best Practices answer does not provide enough information to the user to fully understand the question being asked, the system also allows the user to contact a compliance expert to discuss the matter further. These discussions may take place over instant messaging, email, telephone, or any other means of communication available and provide the user with one-click consulting. The system will keep track of the questions and answers of the user and calculate the residual risk associated with the answers being provided based on a provided control risk and inherent risk.

The system tracks the progress through an audit or activity log that provides changes made and allows the user to add or view comments associated with a particular change. In addition, throughout the process, the user can check the status of the questions through a status toolbar that allows the user to see the topic of each question, which questions have been answered, and a color-coded residual risk for each question. For example, answers that present a high residual risk may be red, while answers that present a low residual risk may be green, with moderate residual risk being yellow. While answering the questions, the system allows the user to attach documents to support the answer such as a specific policy, procedure, or document referenced to support the controls in place. Once the user has answered all of the questions presented, the system will provide the user with a self-assessment final report. This self-assessment report is valuable for maintaining the company's records in addition to being valuable in the event the company is audited by, for example, internal auditing or a regulatory body.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any type of network, including but not limited to: a local area network (LAN); a wide area network (WAN); a cellular network; or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

### Example System Architecture

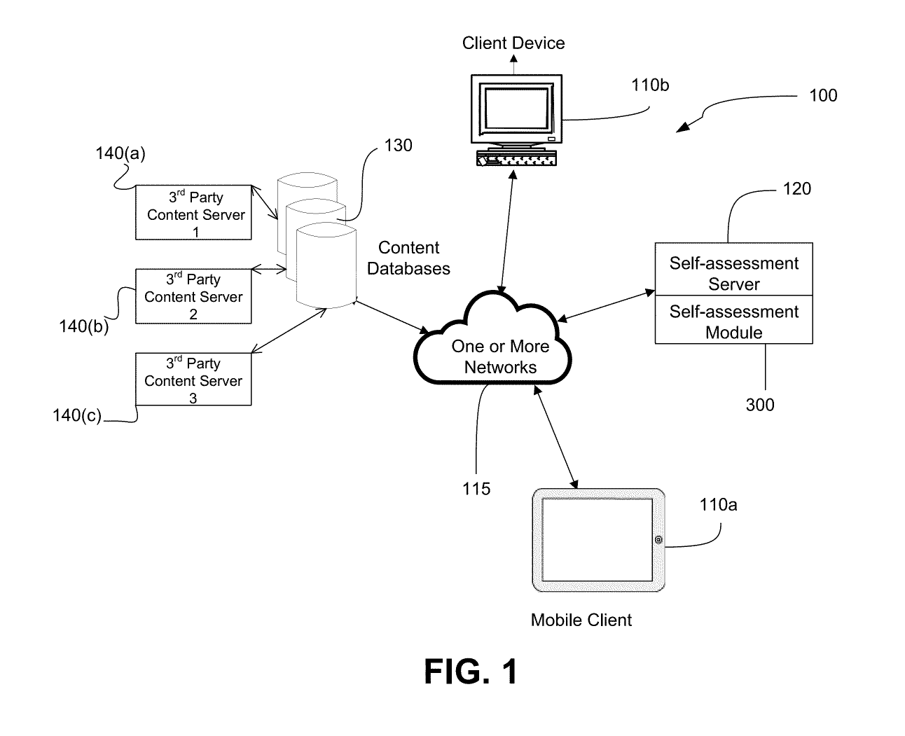

FIG. 1 is a block diagram of a Self-Assessment System 100 according to a particular embodiment. As may be understood from this figure, the Self-Assessment System 100 includes One or More Networks 115, One or More Computing Devices 110a, 110b (e.g., such as a smart phone, a tablet computer, a wearable computing device, a laptop computer, a desktop computer, etc.), Third-Party Content Servers 140a-140c operatively coupled to One or More Content Databases 130, and a Self-Assessment Sever 120 including a Self-Assessment Module 300.

The One or More Networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computing devices). The communication link between the One or More Computing Devices 110a, 110b and the Self-Assessment Server 120, Content Databases 130, and Content Servers 140a-140c may be, for example, implemented via a Local Area Network (LAN) or via the Internet.

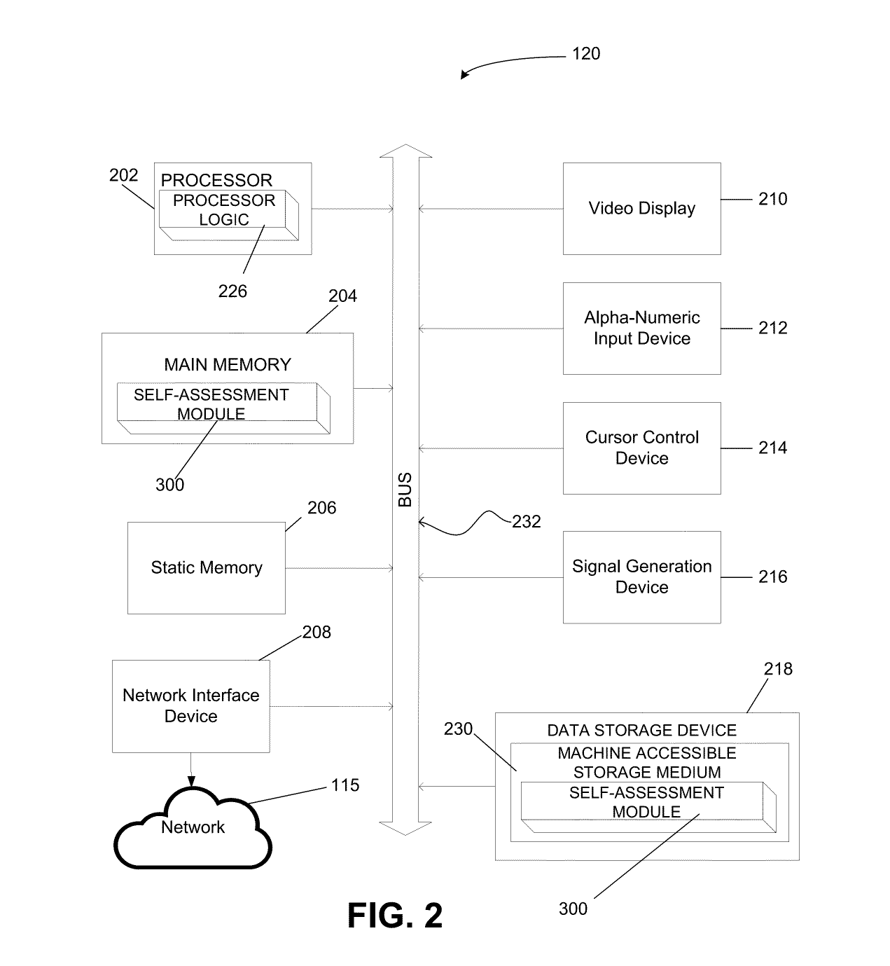

FIG. 2 illustrates a diagrammatic representation of the architecture for the Self-Assessment Server 120 that may be used within the Self-Assessment system 100. It should be understood that the computer architecture shown in FIG. 2 may also represent the computer architecture for any one of the One or More Computing Devices 110a, 110b, or the One or More Content Servers 140a, 140b, 140c shown in FIG. 1. In particular embodiments, the Self-Assessment Server 120 may be suitable for use as a computer within the context of the Self-Assessment System 100 that is configured for presenting questions to a user, receiving answers from the user, storing the answers of the user, calculating risks associated with the various questions, and generating a self-assessment report based on the answers of the user.

In particular embodiments, the Self-Assessment Server 120 may be connected (e.g., networked) to other computing devices in a LAN, an intranet, an extranet, and/or the Internet as shown in FIG. 1. As noted above, the Self-Assessment Server 120 may operate in the capacity of a server or a client computing device in a client-server network environment, or as a peer computing device in a peer-to-peer (or distributed) network environment. The Self-Assessment Server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the term “computing device” shall also be interpreted to include any collection of computing devices that individually or jointly execute a set (or multiple sets) of instructions to perform any one or more of the methodologies discussed herein.

An exemplary Self-Assessment Server 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit (CPU), or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The Publication Server 120 may further include a network interface device 208. The Self-Assessment Server 120 may also include a video display unit 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory computing device-accessible storage medium 230 (also known as a non-transitory computing device-readable storage medium or a non-transitory computing device-readable medium) on which is stored one or more sets of instructions (e.g., the Self-Assessment Module 300) embodying any one or more of the methodologies or functions described herein. The Self-Assessment Module 300 may also reside, completely or at least partially, within the main memory 204 and/or within the processing device 202 during execution thereof by the Self-Assessment Server 120—the main memory 204 and the processing device 202 also constituting computing device-accessible storage media. The Self-Assessment Module 300 may further be transmitted or received over a network 115 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The term “computing device-accessible storage medium” should accordingly be understood to include, but not be limited to, solid-state memories, optical and magnetic media, etc.

### Exemplary System Platform

As noted above, a system, according to various embodiments, is adapted to present questions to a user, receive answers from the user, and store the answers of the user. The system may then generate a self-assessment report based on the answers of the user. The system may also store the reports generated by the self-assessment system for later retrieval by a user.

Various aspects of the system's functionality may be executed by certain system modules, including the Self-Assessment Module 300. The Self-Assessment Module 300 is discussed in greater detail below.

Self-Assessment Module

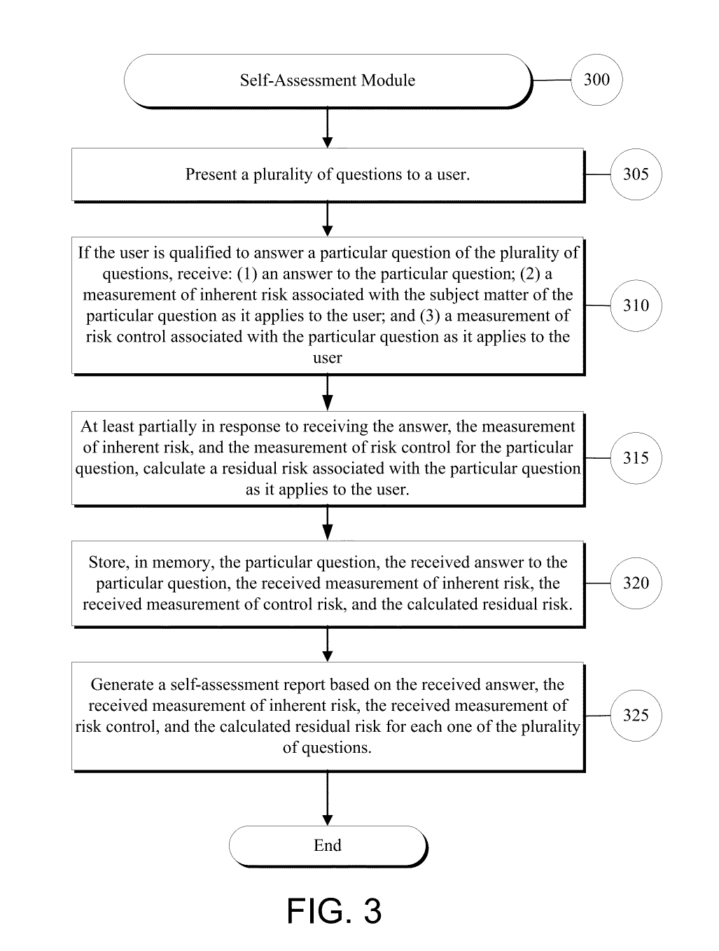

FIG. 3 is a flow chart of operations performed by an exemplary Self-Assessment

Module 300, which may, for example, run on the Self-Assessment Server 120, or any suitable computing device (such as a suitable mobile computing device). In particular embodiments, the Self-Assessment Module 300 may facilitate assessing compliance with one or more policies, rules and/or regulations.

The system begins, in various embodiments, at Step 305 by presenting a plurality of questions to a user. In particular embodiments, the system may be configured to present a plurality of questions using any suitable computing device. In some embodiments, the plurality of questions may be based on Consumer Financial Protection Bureau regulatory requirements. In other embodiments, the questions may be based on company policies and procedures. In still other embodiments, the questions may be based on any number of topics that are pertinent to the particular industry of the company. In various embodiments, the system may present the plurality of questions all at one time. For example, where the system presents, for instance, ten (10) questions to a user, the system can present all ten (10) questions on the same user interface. In other embodiments, the system may present the plurality of questions one at a time. In various embodiments, the plurality of questions presented by the system may include multi-part questions, for instance, a question with a sub-part. For example, in the first question, the user may be required to answer subparts A, B, and C. In various embodiments, the plurality of questions may pertain to the areas of governance, compliance management, originations compliance, and servicing compliance. In other embodiments, the system may present the plurality of questions to a user such as a representative of a financial institution. In other embodiments, the system may present the plurality of questions to a user such as a representative of a non-financial institution.

The system then continues to Step 310 where, the system, if the user is a qualified person to answer a particular question of the plurality of questions, receives (1) an answer to the particular question, (2) a measurement of inherent risk associated with the subject matter of the particular question as it applies to the user, and (3) a measurement of risk control associated with the particular question as it applies to the user. In various embodiments, if the user is not the qualified person to answer the particular question, the system is further configured to (1) receive a request to select a delegate to answer the question; (2) provide an e-mail window that is configured to send an e-mail to the delegate requesting that the delegate complete the particular one of the plurality of questions; and (3) update a status for the particular one of the plurality of questions to include at least a name of the delegate. In various embodiments, the delegate may be a second user.

In particular embodiments, the delegate will be the person more qualified to answer the particular question. In other embodiments, the system may send a delegation message to the delegate that notifies the delegate that they are requested to answer the particular question. In particular embodiments, the system is configured to store the delegate as the qualified person to answer the particular question. In other embodiments, the system may assign the particular question to the delegate. In various embodiments, the system may update a comments section to indicate that the particular question has been delegated to the second user. In still other embodiments, the system may substantially automatically update the comments section when the delegation message is sent to the second user. In various embodiments, the delegate may be auto-populated by the system. In particular embodiments, the delegate may be manually entered by the user. In various embodiments, the system may automatically determine if the user is the qualified person to answer the particular question. In some of these embodiments, the system may use criteria such as the user's title or job description to determine if the user is the qualified person to answer the particular question. In various embodiments, the qualified person to answer the particular question may be the best person to answer the particular question. In particular embodiments, the qualified person may be a supervisor, manager, or an employee from a department to which the particular question applies.

In other embodiments, if the user does not understand the question or is not sure how to answer the question, the system is configured to allow the user to request help for the particular question. In such embodiments, the system may, at least partially in response to receiving a help request from the user, open a dialog box that includes a best practices answer for the particular question. In this embodiment, the system may also be configured to receive a request from the user to use the best practices answer as the answer for the particular question, and populate answer for the particular question with the best practices answer. In various embodiments, the system may further be configured to, at least partially in response to receiving the help request from the user, establish a communication link with a compliance expert. In such embodiments, the communication link may be one of the following: an e-mail, a telephone call, instant messaging, a web conference, sharing the user's desktop, or a text message. In one preferred embodiment, the communication link is instant messaging. In another other preferred embodiment, the communication link is e-mail. In some of these embodiments, the e-mail may be established using the default e-mail program on the user's computer. In still other preferred embodiments, the e-mail program may be integrated into the system so that the system keeps a log of all communications between the user and the compliance expert. In various embodiments, the compliance expert may be a third-party compliance consultant. In particular embodiments, the system will allow the user to request help from a compliance expert at no additional cost. In some of these embodiments, compliance help will be available at no additional cost for a specified period of time (e.g., available at no additional cost for three hours).

In various embodiments, the answer to the question may be either yes, no, or not applicable. In other embodiments, the system may receive the answer to the question from the user by providing the user with multiple answer choices and allowing the user to select the correct answer choice. In particular embodiments, the system may receive the answer to the question from the user by requiring the user to type in the answer to the question. In various embodiments, the measurement of inherent risk associated with the subject matter of the particular question may be measured based on a high, moderate, or low scale. In some of these embodiments, the user may select the measurement of inherent risk by selecting one of several radio buttons associated with a respective measure of the inherent risk. In particular embodiments, the measurement of risk control associated with the particular question may be based on a scale consisting of strong, adequate, or weak. In various embodiments, the measurement of risk control associated with the particular question may be based on the policies the user's company has in place to mitigate the risk to the company associated with the question. In various embodiments, the measurement of inherent risk/risk control may be color-coded (i.e., high risk/weak is shown in red, moderate risk/adequate is shown in yellow, low risk/strong is shown in green). In still other embodiments, the gradation of risks that may be selected may be presented in a high resolution for the user to select from (e.g., low/strong, moderately low/semi-strong, moderate/adequate, moderately high/semi-weak and high/weak).

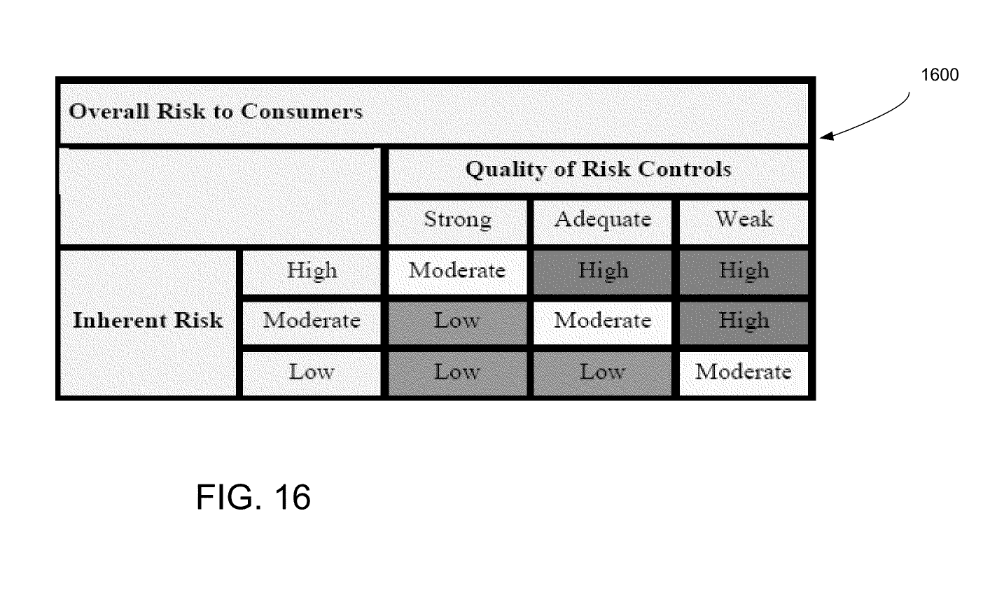

Next, at Step 315, at least partially in response to receiving the answer, the measurement of inherent risk, and the measurement of risk control for the particular question, the system calculates a residual risk associated with the particular question as it applies to the user. In various embodiments, the residual risk may be auto-populated by the system. In particular embodiments, the residual risk may be manually entered by the user. In still other embodiments, the system will calculate the residual risk by adding the inherent risk measurement to the risk control measurement and comparing the result to a predetermined scale. For example, a low inherent risk and a strong control risk results in a low inherent risk, a low inherent risk and an adequate control risk results in a low residual risk, and a moderate inherent risk and a strong control risk results in a medium residual risk. That is, the inherent risk is weighted higher than the control risk. In other embodiments, the control risk may be weighted higher than the inherent risk. In still other embodiments, the weighting of the inherent risk and the control risk may differ for each question depending on the impact the subject matter of the question has on the company. FIG. 16 provides one embodiment of a weighting system for calculating the residual risk. In the example shown in FIG. 16, if the inherent risk is low and the quality of risk control is strong, the residual risk is merely low. However, if the inherent risk is low and the quality of the control risk is weak, then the residual risk is moderate. On the other hand, if the inherent risk is moderate and the quality of the risk control is weak, then the residual risk is high.

In various embodiments, the system is further configured to allow the user to select a status of the particular question from the following: pending, completed, delegated, and in-progress. In various embodiments, the status may be auto-populated by the system. For example, when a question is delegated to a second user, the system automatically selects a radio button for delegated. In particular embodiments, the status may be manually entered by the user.

In yet other embodiments, the system may be configured to allow a user to attach at least one file to their answer to a question. For example, the user may attach a policy and/or procedure to an answer to a question in support of the answer. Thus, in addition to receiving the answer to the question, the system may be configured to receive a request to attach at least one file to the particular question. The request may be made by the user by clicking on a link or a button labeled attach file. At least partially in response to receiving the request to attach a file(s), the system may be configured to open a dialog box that is configured to allow the user to select the at least one file to be attached. The file(s) being attached may be stored locally on the user's computer or it may be stored on a network drive. Once the user selects the file(s) to be attached, the user may click or select a link labeled upload file. At least partially in response to clicking the upload file link or button, the system may upload the file(s) and associate the uploaded file(s) with the particular question. Finally the system may store the uploaded file(s) and the association with the question in memory.

At Step 320, the system stores, in memory, the particular question, the received answer to the particular question, the received measurement of inherent risk, the received measurement of control risk, and the calculated residual risk. In various embodiments, where an uploaded file has been associated with the particular question, the system may also store the uploaded file(s) and association in memory. In particular embodiments, the system is configured to enable the user to access the system to retrieve the stored questions, answers, inherent risk measurements, the control risk measurements, and the residual risk calculations. In other embodiments, the system is configured to substantially automatically store the questions, answers, inherent risk measurements, the control risk measurements, and the residual risk calculations. In various embodiments, the system is configured to allow the user to view the questions that have been answered along with an indication of the residual risk for the question in a status display.

In Step 325, the system generates a self-assessment report based on the received answer, the received measurement of inherent risk, the received measurement of risk control, and the calculated residual risk for each one of the plurality of questions. In various embodiments, the self-assessment report may be a compliance report that includes at least each question of the plurality of questions, the answer for each respective question, and the residual risk calculated for each respective question. In other embodiments, in addition to the question, answer and residual risk, the self-assessment report may also include attached files associated with the questions. In particular embodiments, the system may generate the self-assessment report substantially automatically. In various embodiments, the system may generate the self-assessment report after receiving a request from the user. In particular embodiments, the system will store the self-assessment report for a specified period of time, for instance, for a month, a quarter, a year, or several years. In still other embodiments, the system will generate a cover sheet, table of contents, and a high-level summary of the inherent risk, risk control, and calculated residual risk in the self-assessment report. In yet other embodiments, the user may download the self-assessment report to save to a local disk or network drive.

In various embodiments, the system, when executing the Self-Assessment Module 300, may omit particular steps, perform particular steps in an order other than the order presented above, or perform additional steps not discussed directly above.

Exemplary User Experience

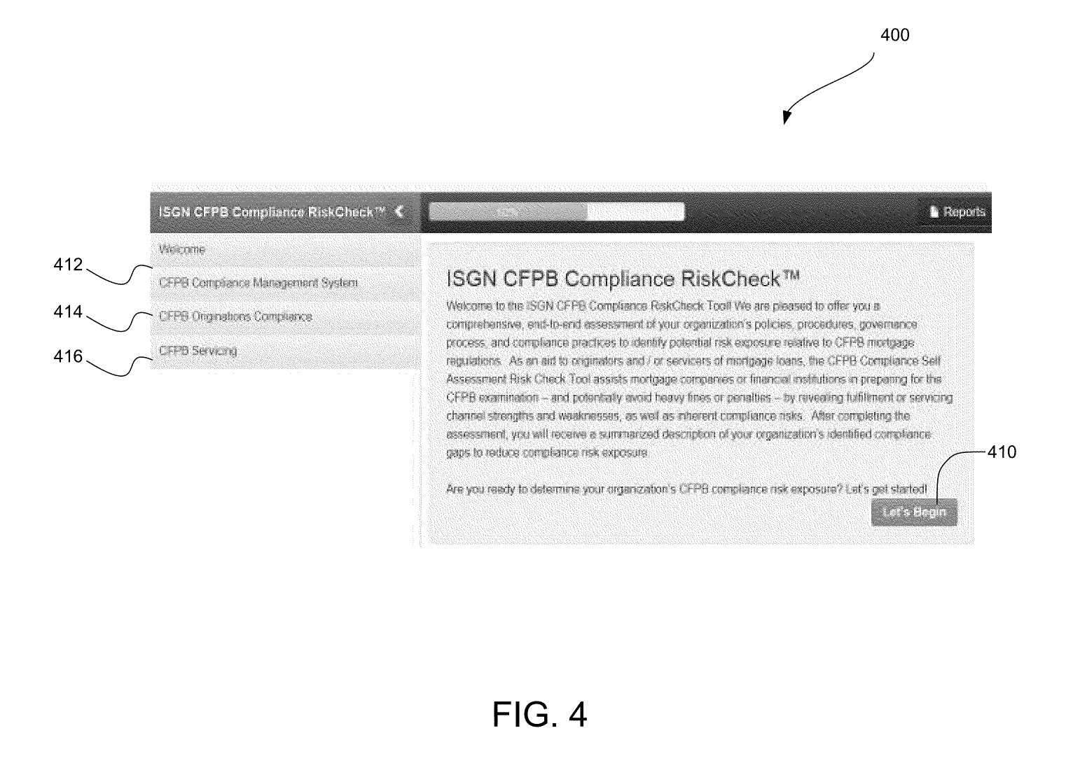

FIG. 4 depicts a user interface 400 that a user may encounter when beginning the process of performing a self-assessment using the Self-Assessment Module 300. As may be understood from this figure, the user interface 400 may include one or more options that the user may select from to conduct the self-assessment through, for instance, a CFPB Compliance Management System module 412, a CFPB Originations Compliance module 414, or a CFPB Servicing Compliance module 416. In other embodiments, these modules may be adjusted to properly reflect the subject matter of the required report and are not limited to the CFPB rules and regulations. The user can begin using the system by selecting the Let's Begin button 410. The user may also select the different compliance policy modules 412, 414, 416 to begin the process.

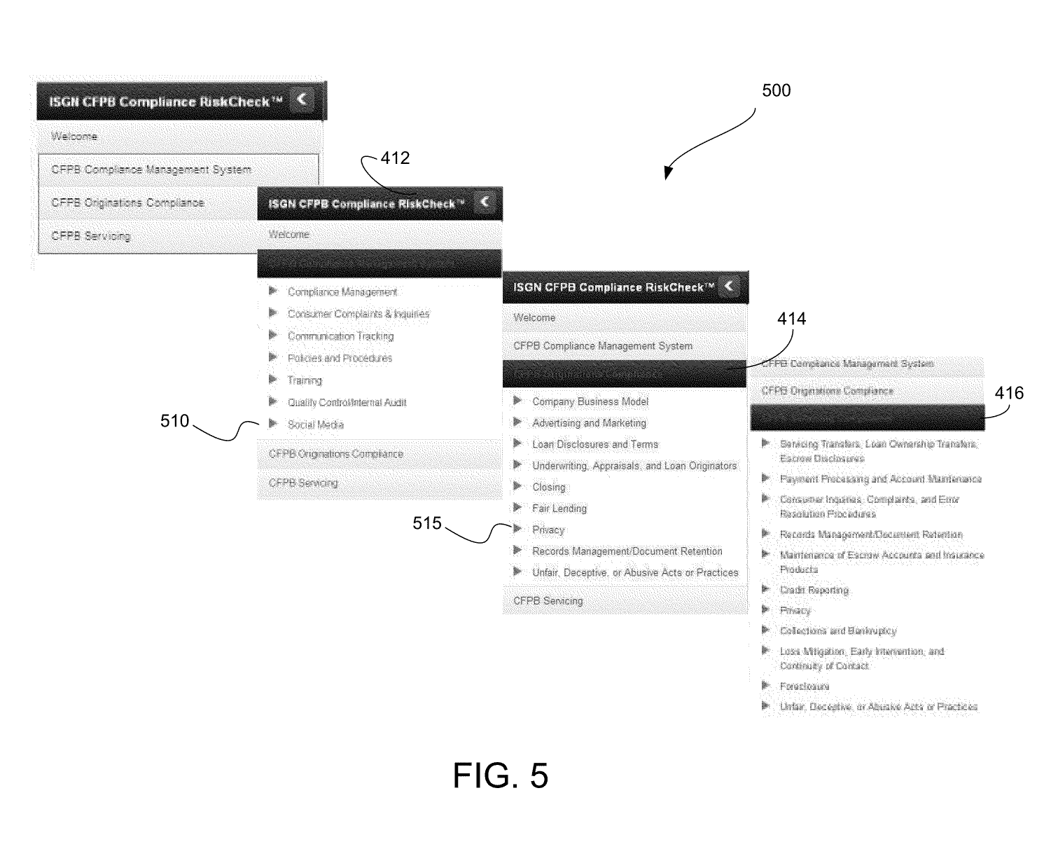

FIG. 5 depicts a sub-topic selection user interface 500 that a user may encounter after selecting one of modules 412, 414, 416 found in FIG. 4. As may be understood from this figure the user is given the option to select a specific module from modules 412, 414, and 416. After selecting the CFPB Compliance Management System module 412, the user is given the option to select a sub-topic on Social Media 510. If instead the user selects the CFPB Originations Compliance module 414, the user can select from a plurality of sub-topics that include Privacy 515. In particular embodiments, the modules may contain any number of sub-topics. In various embodiments, the modules may cover any suitable topic.

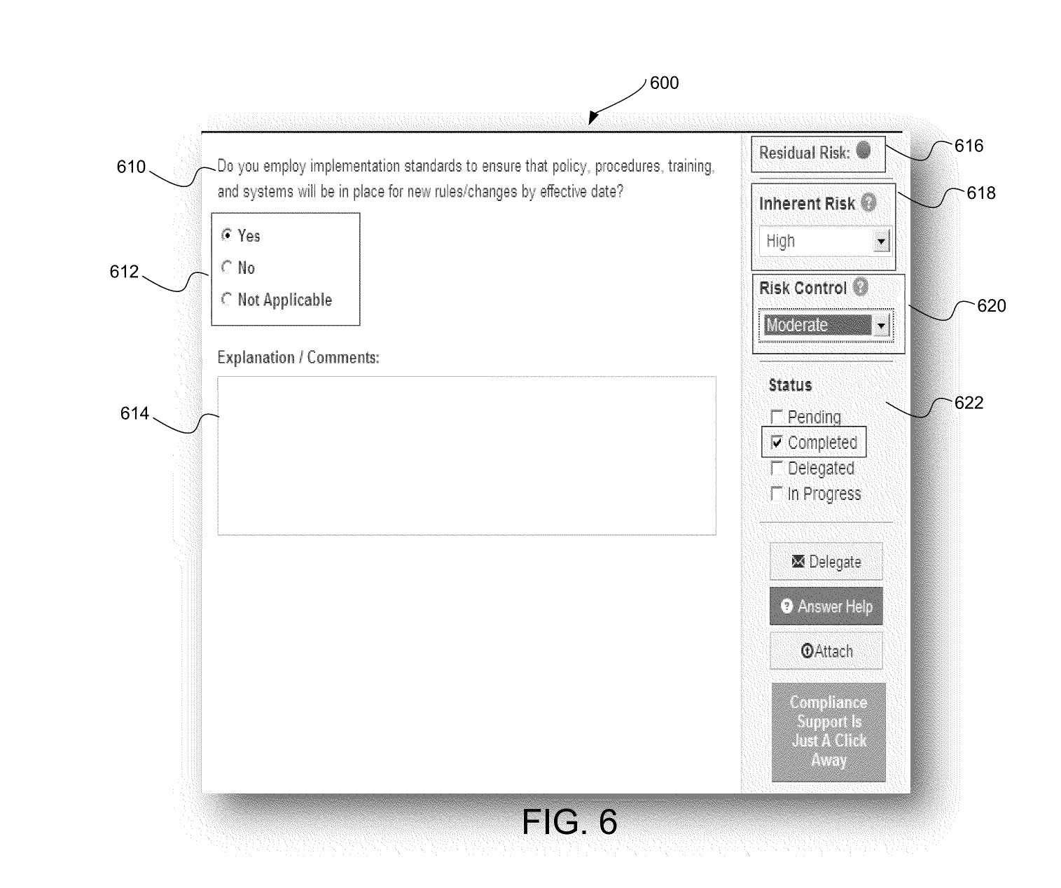

FIG. 6 depicts a question user interface 600 that a user may use to answer one or more questions presented by the system. As may be understood from this figure, the question interface 600 may include a question 610, answer choices 612, an explanation/comments section 614, a residual risk indicator 616, an inherent risk selection menu 618, a risk control selection menu 620, and a status selector 622. In particular embodiments, the answer choices 612 may be in the form of yes, no, or not applicable. In various embodiments, the answer choice may be in any other suitable form including answers that contain full sentences, fill-in the blanks, multiple choice, etc. In particular embodiments, the residual risk indicator is color-coded. For example, red may indicate high risk, yellow moderate risk, and green low risk. In various embodiments, the inherent risk menu 618 and the risk control menu 620 may have a drop down selection where the user may choose, for example, between high, moderate, and low for inherent risk and between strong, moderate and weak for risk control. In particular embodiments, the inherent risk indicator 618 and the risk control indicator 620 will be automatically populated by the system.

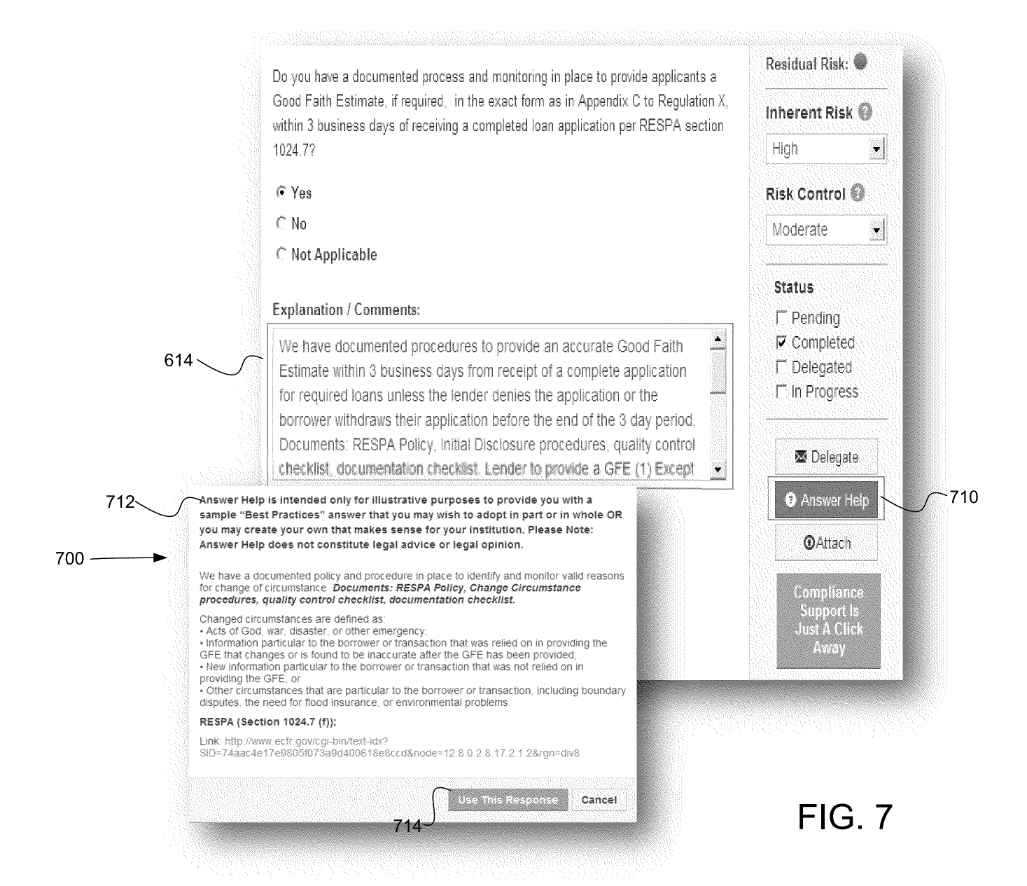

FIG. 7 depicts a help user interface 700 that a user may encounter when seeking help in answering a question. As may be understood from this figure, the user help interface 700 may include an Answer Help button 710. Once the user selects the Answer Help button 710, the system generates an answer help pop-up dialog box 712 that contains an explanation of the question to assist the user in answering the question. In various embodiments, the answer help pop-up dialog box 712 may allow the user to select the suggested answer as the user's answer by allowing the user to select a Use This Response button 714, which will insert the response into the explanation/comments section 614 for the user.

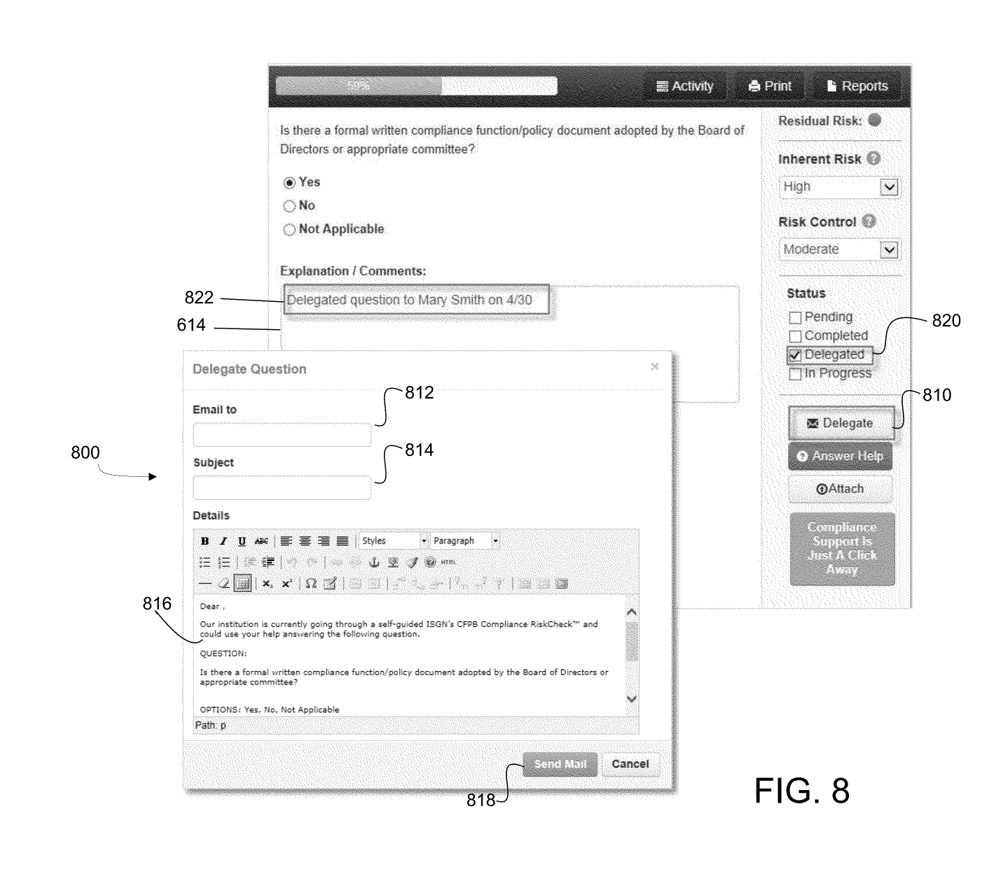

FIG. 8 depicts a delegate user interface 800 that a user may encounter when the user determines that they are not the most qualified user to answer the question and the user decides to delegate the question to a second user. As may be understood from this figure, the delegate interface allows a user to select a Delegate button 810 that generates the delegate user interface 800 where the user may enter information about the second user such as an email address 812 the delegated question will be sent to, the subject matter 814 for the email sent to the delegate, and the body of the email 816. After filling in one or more sections in the delegate user interface 800, the user may then select the Send Mail button 818 to send the email to the delegate. The delegate interface 800 may also include a status indicator that allows the user to select the Delegated button 820 to confirm the question has been delegated. In various embodiments, once the question has been delegated, the system may be configured to automatically indicate in the explanation/comment section 614 that the question has been delegated to the second user and the date the question was delegated. The e-mail received by the delegate may be configured to allow the user to select a link that brings the user to the delegated question and allows the second user to answer the question and save the answer to the system. In various embodiments, the system may be configured to notify the user that delegated a question when the delegated question has been answered by the second user so that the user may examine the answer and accept the answer supplied by the second user. In other embodiments, the system may automatically accept the answer supplied by the second user and the system may be configured to change the status to completed once the second user answers the delegated question.

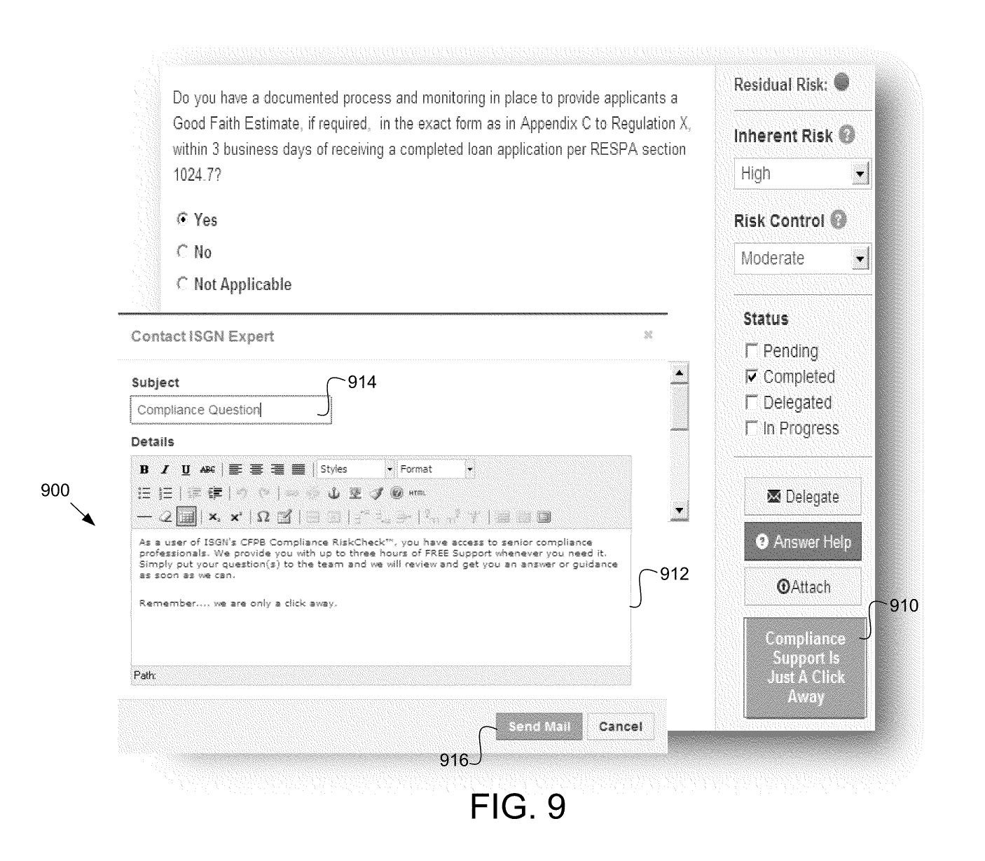

FIG. 9 depicts a one-click consulting user interface 900 that allows a user to communicate with a compliance expert. As may be understood from this figure, when the user selects the Compliance Support button 910, the one-click consulting user interface 900 opens and establishes a communication channel that allows the user to send a message to a compliance expert. The one-click consulting user interface 900 allows the user to enter any information they are requesting from the compliance expert into the details field 912, enter a subject in a subject data field 914 and then click a Send Mail button 916 to close the one-click consulting user interface 910 and send the question to the compliance expert. In other embodiments, the communication channel may be an instant message, a video chat, a screen sharing system or any other suitable communication channel that allows the compliance expert to communicate with the user.

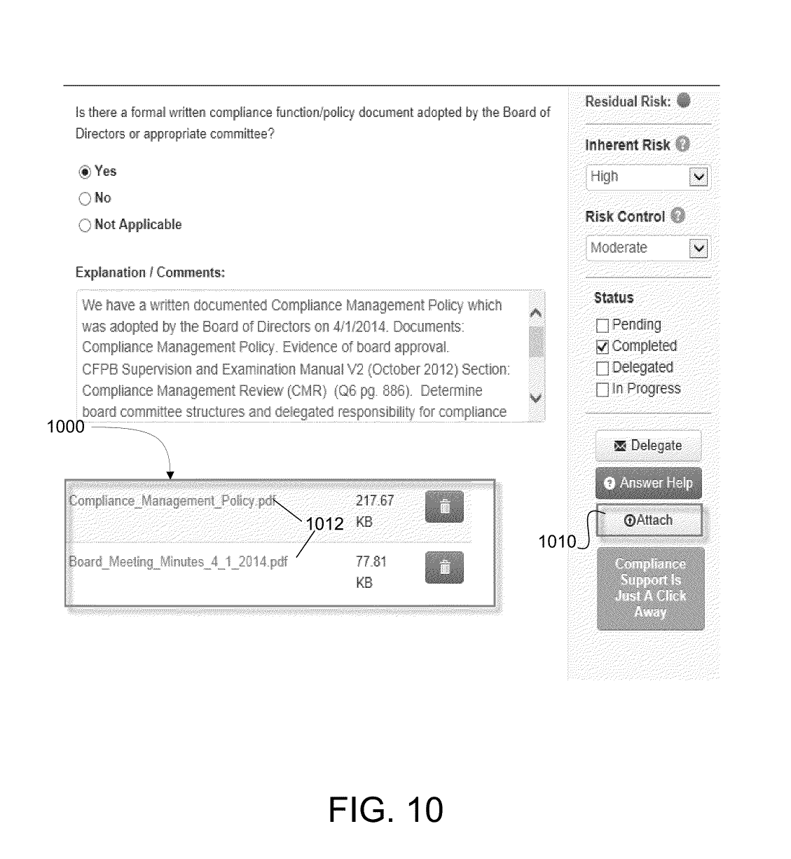

FIG. 10 depicts an attachment user interface 1000 where a user can attach files to the question to support their answer to the question. As may be understood from this figure, when the user selects an Attach button 1010, the attachment user interface 1000 opens and allows a user to select one or more files to upload to the system. Once the user selects the file(s) to attach, the user clicks a submit button (not shown) that causes the system to upload the file(s) and associate the files with the question. That is, the attached files one-click consulting user interface 1012 is shown in the attachment user interface 1000. Once the file(s) are attached, the files are associated with the question and stored in memory.

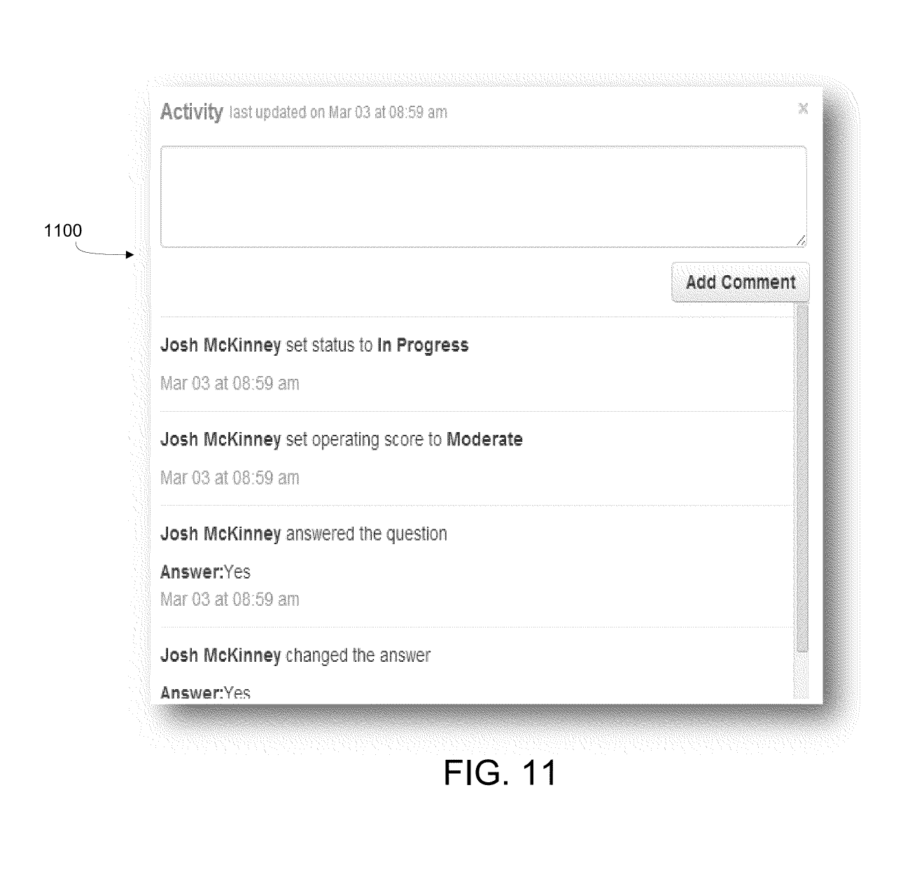

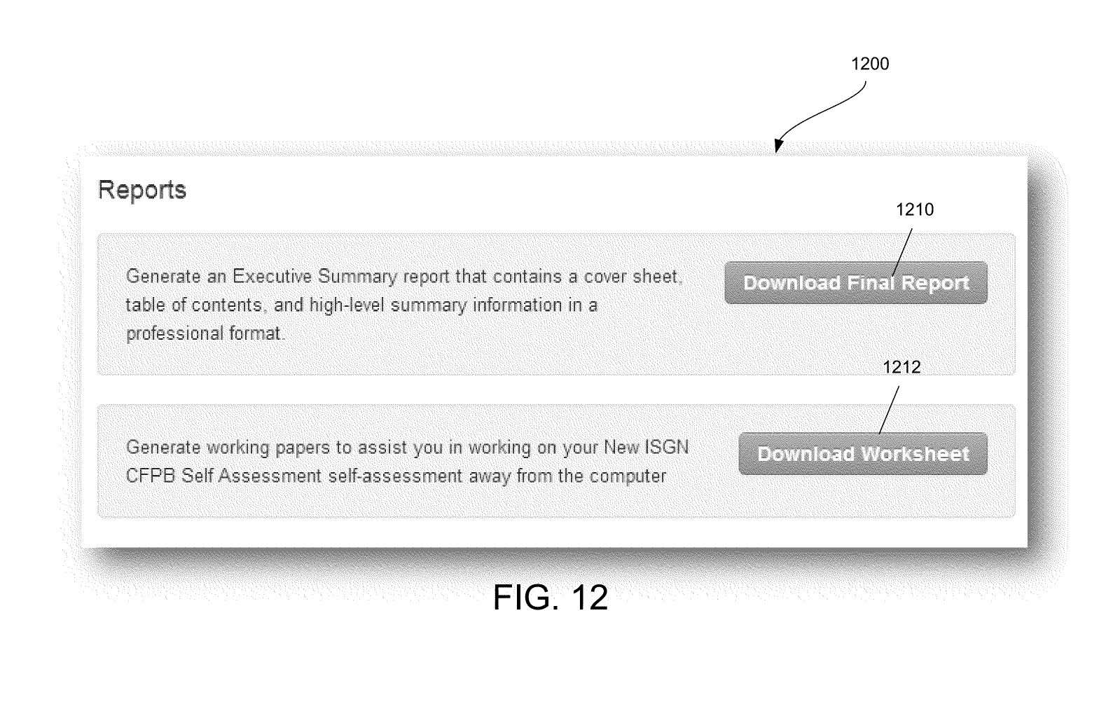

FIG. 11 generally depicts an activity log user interface 1100 that the user may view to show which users accessed the system and what activity was associated with the user. FIG. 12 generally depicts a report user interface 1200 that allows the user to select from one of two reports. The first report button 1210 allows the user to generate an executive summary report that contains a cover sheet, table of contents and a high level summary of the information (e.g., the questions, answers, residual risk, etc. The second report button 1212 allows the user to generate working papers. For example, a user may generate paper versions of the questions so that the user may work on open questions when away from a computer.

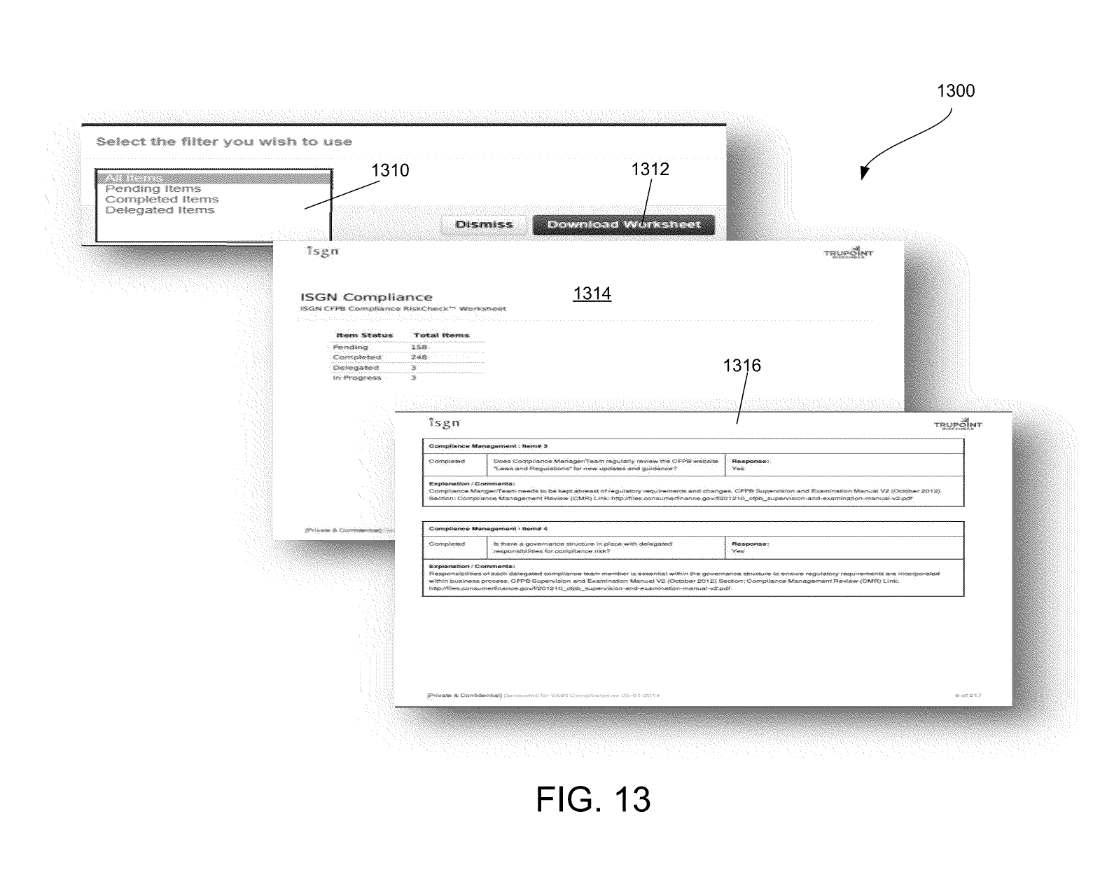

FIG. 13 generally depicts a report worksheet user interface 1300 that opens when the second report button 1212 is selected by the user. The user may filter the worksheets by selecting the type of worksheet items they want from a filter menu 1310. When the user selects a download worksheet button 1312, a worksheet summary page 1314 is generated along with one or more worksheet pages 1316.

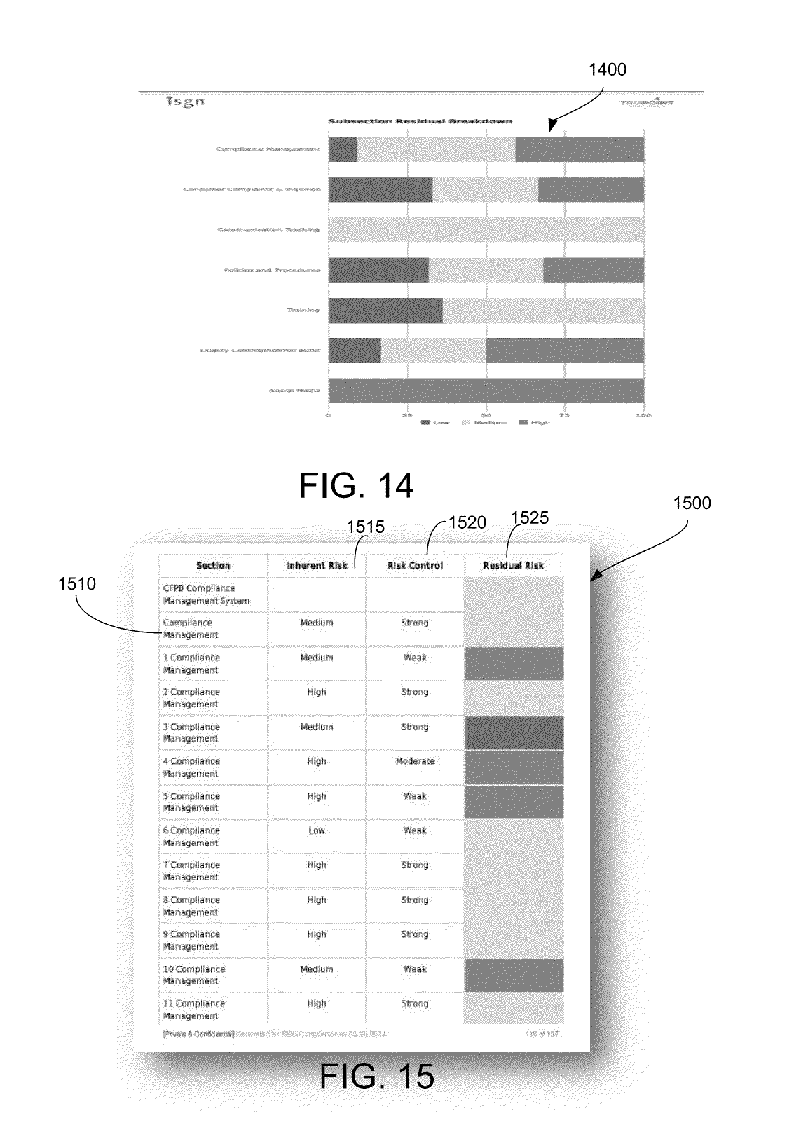

FIG. 14 generally depicts a graph 1400 that illustrates areas of risk in each module and sub-topic within the module. FIG. 15 generally illustrates a summary table 1500 that identifies each module and question in a module 1510, an inherent risk 1515 associated with each question, a control risk 1520 associated with each question and a calculated residual risk 1525 for each question.

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A computer system comprising:
a. at least one processor; and
b. memory operatively coupled to the at least one processor;
wherein the at least one processor is configured to:
i. present a plurality of questions to a user;
ii. if the user is qualified to answer a particular question of the plurality of questions:
receive an answer to the particular question;
receive a measurement of inherent risk associated with the subject matter of the particular question as it applies to the user;
receive a measurement of risk control associated with the particular question as it applies to the user;
iii. at least partially in response to receiving the answer, the measurement of inherent risk and the measurement of risk control for the particular question, calculate a residual risk associated with the particular question as it applies to the user;
iv. store, in memory, the particular question, the received answer to the particular question, the received measurement of inherent risk, the received measurement of control risk, and the calculated residual risk; and
v. generate a self-assessment report based on the received answer, the received measurement of inherent risk, the received measurement of risk control and the calculated residual risk for each one of the plurality of questions.

2. The system of claim 1, wherein the plurality of questions are related to Consumer Financial Protection Bureau regulatory requirements.

3. The system of claim 1, wherein the at least one processor is further configured to allow the user to select a status of the particular question from a group consisting of:
a. pending;
b. completed;
c. delegated; and
d. in progress.

4. The system of claim 1, wherein the at least one processor is configured to:
a. receive, from the user, a request to attach at least one file to the particular question;
b. open a dialog box at least partially in response to receiving the request to attach the at least one file, wherein the dialog box is configured to allow the user to select the at least one file to be attached;
c. receive a selection of the at least one file;
d. upload the at least one file;
e. associate the uploaded at least one file with the particular question; and
f. store, in memory, the at least one file and an association to the particular question.

5. The system of claim 1, wherein the at least one processor is configured to allow the user to request help for the particular question.

6. The system of claim 5, wherein the at least one processor is configured to, at least partially in response to receiving a help request from the user, open a dialog box that includes a best practices answer for the particular question.

7. The system of claim 6, wherein the at least one processor is configured to:
a. receive a request from the user to use the best practices answer as the answer to the particular question; and
b. populate the answer to the particular question answer with the best practices answer.

8. The system of claim 5, wherein the at least one processor is configured to, at least partially in response to receiving the help request from the user, establish a communication link with a compliance expert.

9. The system of claim 8, wherein the communication link is selected from a group consisting of:
a. e-mail;
b. a telephone call;
c. instant messaging;
d. a web conference; and
e. sharing the user's desktop.

10. The system of claim 9, wherein the communication link is instant messaging.

11. A computer-implemented method of self-assessing compliance with regulatory rules, the method comprising:
a. presenting, by a processor, a plurality of questions that are based on regulatory requirements;
b. receive, by a processor:
i. an answer for each one of the plurality of questions for an organization;
ii. a measure of inherent risk associated with each one of the plurality of questions for the organization; and
iii. a measure of control risk associated with each one of the plurality of questions for the organization; and
c. calculate, by a processor, a residual risk for each one of the plurality of questions, wherein the residual risk is at least based in part on the received measure of inherent risk and the received measure of control risk for the respective question.

12. The computer-implemented method of claim 11, further comprising the step of generating, by a processor, a compliance report that includes at least each question of the plurality of questions, the answer for each respective question, and the residual risk calculated for each respective question.

13. The computer-implemented method of claim 12, further comprising the step of exporting the compliance report to a file.

14. The computer-implemented method of claim 11, further comprising:
a. receiving, by a processor, a request for help for a particular question from the plurality of questions;
b. establishing, by a processor, a communication channel between the user and a third party compliance consultant; and
c. transmitting, by a processor, a message from the user to the third party compliance consultant.

15. The computer-implemented method of claim 14, wherein the communication channel is e-mail.

16. The computer-implemented method of claim 11, further comprising:
a. receiving, by a processor, a request to attach at least one file to the particular one of the plurality of questions;
b. facilitating, by a processor, uploading of the at least one file;
c. associating, by a processor, the uploaded at least one file with the particular one of the plurality of questions; and
d. storing, by a processor, the uploaded at least one file.

17. A computer system for conducting an assessment for compliance with a set of rules, comprising:
a. a means for presenting a plurality of questions to a user;
b. a means for receiving an answer for each respective one of the plurality of questions;
c. a means for receiving a measure of an inherent risk associated with each respective one of the plurality of questions;
d. a means for receiving a measure of a control risk associated with each respective one of the plurality of questions;
e. a means for calculating a residual risk for each one of the plurality of questions, wherein the residual risk is at least partially based on the received measure of the control risk and the received measure of the inherent risk for the respective question; and
f. a means for associating at least one of the received answer, the received measure of inherent risk, the received measure of control risk and the calculated residual risk with the respective question.

18. The computer system of claim 17, further comprising a means for providing help to the user.

19. The computer system of claim 18, further comprising a means of establishing communication between the user and a third party compliance expert.

20. The computer system of claim 17, further comprising a means for attaching at least one file to a particular one of the plurality of questions.
